(19) United States
(12) Patent Application Publication
(10) Pub. No.: US 2002/0005837 A1
(43) Pub. Date: Jan. 17, 2002

(54) Portable device with text entry

(75) Inventors: Graham G. Thomason, Redhill (GB); Neil C. Bird, Horsham (GB); Gerard F. Harkin, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/945,857

(22) Filed: Sep. 4, 2001

(30) Foreign Application Priority Data
Feb. 9, 2000 (GB) 0021569.9

(51) Int. Cl. G09G 5/00

(52) U.S. Cl. 345/169

(57) ABSTRACT

A portable electronic device (1) has a keypad for entering alphanumeric characters. Some of the keys include a fingerprint sensor (2) and for each of these keys a different character may be selected for entry by using a different finger. The device is provided with a reference set of fingerprints of the authorised user or users, so unauthorised users cannot enter characters. A high resolution fingerprint sensor may be used for validating a user for secure transactions, while a lower resolution sensor may be used for differentiating between a small number of fingerprints. Size and interconnection complexity can be minimised by providing fingerprint sensors that are smaller than a fingerprint, and entering a fingerprint by wiping a finger across the sensor.

The invention relates to a portable electronic device having means for entering characters and has particular, but not exclusive, application to portable radio devices such as mobile telephones, data terminals and pagers, and to hand held computers.

Portable electronic devices such as mobile telephones are being designed increasingly small. In parallel, there is an increasing requirement for entering characters such as alphanumeric text into such devices, for example for email communication while on the move. As a result there is a need for a small-sized man-machine interface that is easy to operate and can handle typically 40 or more characters.

One known way of achieving miniaturisation is to use small keys, which, for example, may be arranged in the standard QWERTY keyboard configuration. However, as portable electronic devices are made smaller, such a miniaturised keyboard configuration becomes increasingly difficult to operate.

Another known way of achieving small size is to reduce the number of keys by using multi-character keys in which repeated presses of a key, or continuous pressing of a key for different durations, results in different characters being entered.

Yet another known method is to use cursor control keys and an ‘enter’ key to select characters from a displayed alphabet.

The above methods can be slow and prone to error.

Such electronic devices commonly incorporate protection against unauthorised users, for example by means of a password. Security may be compromised if the password is revealed, and also authorised use can be denied if the password is forgotten.

An object of the present invention is to facilitate text entry on a portable electronic device.

According to the invention there is provided a portable electronic device having character selecting means for selecting characters from a character set for entry into the device, the character selecting means comprising a plurality of fingerprint sensing areas, each of the plurality of fingerprint sensing areas being equipped to sense a fingerprint, means for recognising each of a plurality of fingerprints of at least one user, and means for determining a character associated with a combination of one of the plurality of fingerprints sensed by one of the plurality of the fingerprint sensing areas.

In one embodiment of the invention the portable electronic device has a store containing the fingerprint data for a plurality of fingers of one or more users, and means for comparing a sensed fingerprint with the stored fingerprint data. A character is entered into the device by placing a finger on one of the fingerprint sensing areas. The particular character entered is determined by the choice of finger and the choice of fingerprint sensing area. The device determines which character is selected by determining which finger has been sensed and which fingerprint sensing area has been actuated.

By this means, the number of “keys”, as represented by fingerprint sensing areas, on the device can be kept small. For example, 40 different characters may be selected by means of 10 different keys in conjunction with four different fingers.

In a second embodiment of the invention the resolution of each of the fingerprint sensing areas may, optionally, not be equal. For example, a fingerprint sensed on a fingerprint sensing area having a higher resolution than the other fingerprint sensing areas may be used by the device to validate the user by means of comparison with a reference fingerprint, and a fingerprint sensed on the other fingerprint sensing areas may be used for character entry. A reference fingerprint may be made available for a single user, or for each of a plurality of valid users to enable the device to validate a plurality of users. The use of at least two different resolutions for the different fingerprint sensing areas, rather than a common, high resolution for each fingerprint sensing area, enables a reduction in drive electronics, power consumption and cost.

In a further embodiment of the invention at least one of the plurality of fingerprint sensing areas is of smaller area than a fingerprint, and a fingerprint is sensed by wiping a finger across the sensing area. By this means the area occupied by the keys may be reduced, and also the drive electronics and cost may be reduced. Advantageously, a higher resolution fingerprint sensor area as described above may also be of smaller area than a fingerprint.

In a yet further embodiment of the invention a fingerprint sensing area may be contoured in sympathy with the fingerprint region of a finger to assist the user to position the finger on the fingerprint sensing area, or to assist the user to wipe the finger across the fingerprint sensing area.

In a still further embodiment of the invention a fingerprint sensing area may be pressure sensitive and increased pressure may be applied by any finger, or alternatively by a predetermined finger, to effect a control function. The pressure may be sensed by measuring the area of contact between the finger and the fingerprint sensing area.

The invention will now be described, by way of example, with reference to the accompanying drawings wherein:

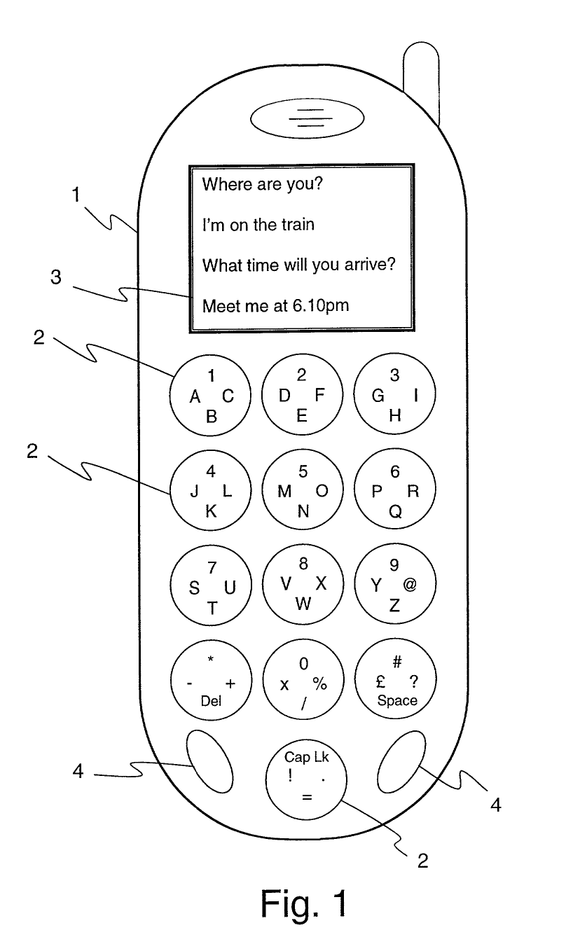

FIG. 1 illustrates a mobile telephone embodying the invention; and

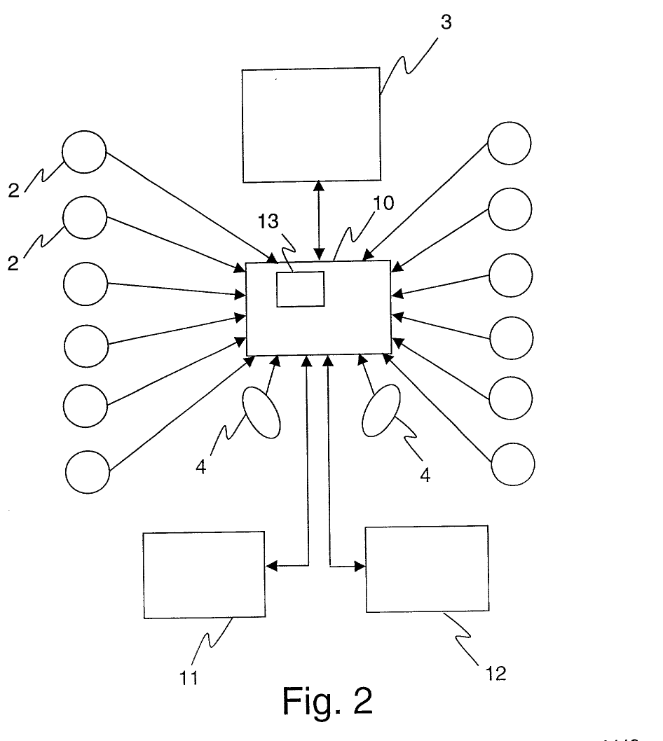

FIG. 2 shows a block schematic diagram of a mobile telephone embodying the invention.

In the drawings the same reference numerals have been used to indicate corresponding features.

Referring to FIG. 1 there is shown a mobile telephone 1 comprising a display 3 and a key pad. The key pad comprises a plurality of keys, each key comprising a fingerprint sensing area 2. The fingerprint sensing areas 2 may be implemented as independent sensors or as different areas of a larger sensor. Also, fingerprint sensing areas 2 may be implemented within the display 3. Typically each fingerprint sensing area 2 is labelled with the characters that may be entered by means of that area, as described below. Control functions may also be implemented by using the fingerprint sensing areas 2, and these are described below. The keypad further comprises additional keys 4 which may be used for performing control functions such as “on-hook”, “off-hook”, initiating transmission of messages, and viewing received messages. The additional keys 4 may also be used in conjunction with the fingerprint sensing areas to implement control functions, however methods of performing control functions using the additional keys 4 are not described in this specification. Furthermore, the display 3 may include icons to assist the user in the execution of control functions, but these icons are not illustrated in FIG. 1.

Prior to initial use for character entry, the device must be provided with a reference set of fingerprints of the user or users. One way of providing a reference set of fingerprints is to set the device into a program mode and then to permit the device to read, in a prearranged order or on prearranged fingerprint sensor areas 2, each finger to be used. Another, more secure way of providing a reference set of fingerprints is on a smart card, although this option is not illustrated in the Figures.

After the device has been provided with a reference set of fingerprints, a user may select a character for entry into the device by placing a finger on one of the fingerprint sensing areas. A choice of character may be made by combined choice of finger and choice of fingerprint sensing area. For example, a forefinger may be used to select digits 1, 2 and 3 on the left, middle and right fingerprint sensors respectively of the top row of the keypad in FIG. 1. Similarly, the ring finger may be used to select the letters B, E and H on the same row. Any desired assignment of characters to fingers and fingerprint sensing areas may be used.

As each character is selected it is displayed to provide confirmation of selection to the user. Errors in selection may be corrected by selecting a “delete” character.

A keypad comprising N fingerprint sensing areas may be used with four different fingers to enter N×4 different characters. Fewer fingerprint sensing areas are required if two handed operation is used.

Referring to FIG. 2, there is provided processor 10 connected to a plurality of fingerprint sensors 2, display 3, additional keys 4, reference fingerprint store 11, and other electronics 12 necessary for the operating of the mobile telephone, such as a radio transceiver. The processor includes a look-up table of characters 13, although alternatively this look-up table could be carried or supplied in a storage device coupled with the processor.

During programming with a reference set of fingerprints, fingerprints are sensed by one or more fingerprint sensing areas 2 and supplied to the processor 10. The processor then stores the reference fingerprints into reference fingerprint store 11.

During character entry, a fingerprint is sensed by one of the plurality of fingerprint sensing areas 2 and supplied to the processor 10. The processor 10 makes a temporary record of which fingerprint sensing area 2 the fingerprint was sensed by. The processor 10 then compares the sensed fingerprint with the fingerprints stored in the reference fingerprint store 11 and makes a temporary record of which finger the sensed fingerprint corresponds to. By means of the look-up table 13, the processor 10 converts a combination of fingerprint sensing area 2 and finger into a character which is supplied to the display 3. The temporary records may then be erased.

Any would-be user for whom no reference set of fingerprints is provided is unable to enter characters. The invention thereby can provide security against unauthorised use of the device.

The extent of interconnection electronics and power consumption is related to the resolution provided by the fingerprint sensing areas 2. The resolution required to differentiate between four different fingers can be less than the resolution required to reliably identify a particular user for applications such as electronic funds transfer. Therefore, one option for reducing interconnection complexity and power consumption is to have a different resolution for different fingerprint sensing areas 2. For example, in FIG. 2, the lower-most fingerprint sensing area could be equipped with a higher resolution than the other fingerprint sensing areas and a user would identify himself to the device using the high resolution fingerprint sensing area prior to engaging in character entry for a secure application.

Optionally, to reduce the interconnection complexity and reduce the space required by a fingerprint sensing area 2, a fingerprint sensing area 2 may be smaller than a fingerprint, and a fingerprint is sensed as a finger is wiped across the area. Such a reduced size fingerprint sensing area may comprise, for example, a linear sensor or a plurality of linear sensors.

Optionally, a combination of a particular fingerprint and a particular fingerprint sensing area may be used to effect a control function, for example a control function typically effected by a computer mouse button.

Optionally, the processor 10 may determine which finger is placed on a fingerprint sensing area 2 and track movement of the finger across the fingerprint sensing area 2, reconfirming the fingerprint when the finger has moved, and convert the movement into an input function which may be a control function, such as display scrolling or displayed cursor movement, or may be a data entry function, such as character recognition or data selection.

Optionally, the processor 10 may determine which finger is placed on a fingerprint sensing area 2 and track movement of the finger across the fingerprint sensing area 2 without reconfirming the fingerprint when the finger has moved, and convert the movement into an input function which may be a control function, such as display scrolling or displayed cursor movement, or may be a data entry function, such as character recognition or data selection.

Optionally, a fingerprint sensor area may be pressure sensitive such that a pressure increase may be applied by any finger, or alternatively by a predetermined finger, to effect a control function, for example a control function typically effected by a computer mouse button. Increased finger pressure may be sensed by measurement of the area of contact between the finger and the fingerprint sensing area.

Optionally, the fingerprint sensing areas may be mounted on mechanical switches, for example to provide a familiar feel to the user or to provide an additional mechanical mode of actuation.

Optionally, the surface of the fingerprint sensing areas may be curved to receive a finger in order to assist the user to position a finger.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the art of portable electronic device design and the art of man machine interface design, and which may be used instead of or in addition to features already described herein.

1. A portable electronic device having character selecting means for selecting characters from a character set for entry into the device, the character selecting means comprising a plurality of fingerprint sensing areas, each of the plurality of fingerprint sensing areas being equipped to sense a fingerprint, means for recognising each of a plurality of fingerprints of at least one user, and means for determining a character associated with a combination of one of the plurality of fingerprints sensed by one of the plurality of the fingerprint sensing areas.

2. A portable electronic device as claimed in claim 1, in which at least one of the plurality of fingerprint sensing areas has a higher resolution than the other of the plurality of fingerprint sensing areas and further comprising means for validating a predetermined user from a fingerprint sensed on said higher resolution fingerprint sensing area.

3. A portable electronic device as claimed in claim 1 or 2, in which at least one of the plurality of fingerprint sensing areas is of smaller area than a fingerprint and a fingerprint is sensed by wiping a finger across the sensing area.

4. A portable electronic device as claimed in any of claims 1 to 3, in which at least one of the plurality of fingerprint sensing areas is contoured in sympathy with the fingerprint area of a finger.

5. A portable electronic device as claimed in any of claims 1 to 4, further comprising means for tracking movement of a recognised fingerprint across a fingerprint sensing area, and means for translating the movement of the recognised fingerprint into one of a control function and a data entry function.

6. A portable electronic device as claimed in any of claims 1 to 4, further comprising means for tracking movement of a recognised fingerprint across a fingerprint sensing area without reconfirming the identity of the fingerprint, and means for translating the movement into one of a control function and a data entry function.

7. A portable electronic device as claimed in any of claims 1 to 6, wherein one of the plurality of fingerprints sensed by one of the plurality of fingerprint sensing areas effects a control function.

8. A portable electronic device as claimed in any of claims 1 to 7, wherein a fingerprint sensing area is pressure sensitive such that a pressure increase may be applied to effect a control function.

9. A portable electronic device as claimed in any of claims 1 to 7, wherein a fingerprint sensing area is pressure sensitive such that a pressure increase by a predetermined finger may be applied to effect a control function.

10. A portable electronic device as claimed in claim 8 or 9, wherein finger pressure is sensed by measuring the area of contact between the finger and the fingerprint sensing area.
